(19) United States
(12) Patent Application Publication
(10) Pub. No.: US 2024/0333414 A1
(43) Pub. Date: Oct. 3, 2024

(54) LOW POWER REMOTE SENSOR OPTICAL GATE TRANSMISSION SYSTEM ARCHITECTURE SOLUTIONS

(71) Applicant: NETGAMI SYSTEM L.L.C., Short HIlls, NJ (US)

(72) Inventors: John LYNN, Easton, PA (US); Eric LYNN, Easton, PA (US)

(73) Assignee: NETGAMI SYSTEM L.L.C., Short HIlls, NJ (US)

(21) Appl. No.: 18/129,944

(22) Filed: Apr. 3, 2023

(51) Int. Cl. H04J 14/02; G01D 5/26; H04B 10/25

(52) U.S. Cl. CPC H04J 14/0202; G01D 5/268; H04B 10/25

(57) ABSTRACT

An optical fiber link includes a first pair of fiber cable link including a first up fiber and a first down fiber; a multi-wavelength controller generating a plurality of wavelengths and send the plurality of wavelengths to a first AD-remote sensor station by a first down fiber. The first AD-remote sensor station drops a first number of the plurality of wavelengths for a first number of remote sensors in the first AD-remote sensor station to process, allows the rest of the plurality of wavelengths to pass to a second Ad-remote sensor station, adds the dropped first number of the plurality of wavelengths processed by the first number of remote sensors back to the first up fiber, and sends a first combined wavelengths including the first number of the plurality of wavelengths processed by the first AD-remote sensor station back to the multi-wavelength controller.

### BACKGROUND OF THE INVENTION

### 1. Field of the Invention

The present invention relates to an optical fiber link, particularly to an optical fiber link which provides an optical link with bidirectional half-duplex or the unidirectional communication channel with very little power for the multiple remote sensors. The present invention can provide multiple remote sensors optical transmission in one pair of fiber optical cable. The present invention can also provide fault tolerance with multiple fiber cable pairs.

### 2. Background of the Invention

An optical link for a low power remote sensor optical communication could include local host control devices, fiber links, functional blocks, and the remote sensor devices. FIG. 1 illustrates a low power remote sensor optical communication links solution. The local host control device 10 communicates with remote sensor device 20 through the fiber cable. Normally, the Microcontroller Unit (MCU) 11 generates the control or communication data and converts it to the host transmitting (HTX) signals, HIGH or LOW, and sends the HTX signals to the electrical-to-optical (E/O) converter 12 which converts the HTX signals to the laser beam optical signals. When the HTX is in HIGH state, the laser beam will be turned on or in high power state. When the HTX is in LOW state, the laser beam will be turned off or in low power state. The laser beam optical signals are carried by the downstream fiber link 31 to the Optical gate 21 of the remote sensor devices which converts the laser beam's high and low power states to the sensor receiving (SRX) signals, HIGH or LOW state, then sends the SRX signal to the sensor device 22. The sensor device 22 sends the sensor transmitting (STX) signals, HIGH or LOW state, to the Optical gate 21 which passes or block the laser beam high power and low power optical signals with the STX signals, HIGH or LOW state. The laser beam optical signals are carried by the upstream fiber link 32 to O/E converter 13 of the local host control device 10 which converts the laser beam optical signal to the host receiving (HRX) signals, HIGH or LOW state. This signal is then received by the MCU 11. The MCU 11 calculates and recovers the STX signals from the sensor device 22.

For the remote low power sensor applications, the communication only can provide one optical fiber pair for one remote sensor. It is not a sufficient solution for the most of the remote sensor networks which require multiple remote sensors and multiple locations with one pair of the fiber optical link.

### SUMMARY OF THE INVENTION

Accordingly, it is an objective of the present invention to provide an optical fiber link method for remote low power solution for multiple remote sensors per AD-Remote (ADD/DROP-Remote) Sensor Station. It also can provide the multiple AD-Remote Sensor Stations cascaded over the same pair of fiber optical link.

In order to provide the fault tolerance to prevent interrupting service due to the fiber cable link failure, the present invention can provide the Fault Tolerance AD-Remote Sensor Station with the multiple fiber cable links to carry the laser beams. When one optical cable is cut or broken, the other optical fiber cables can still transmit the laser beams without service interruption. The same system architecture also can be used to detect the cut or broken optical fiber link location between Fault Tolerance AD-Remote Sensor Stations. It also can provide non-interrupting service to install new Fault Tolerance AD-Remote Sensor Station.

### BRIEF DESCRIPTION OF THE DRAWINGS

The present invention will become better understood from the detailed description given hereinbelow and the accompanying drawings which are given by way of illustration only, and thus are not limitative of the present invention, and wherein:

FIG. 1 is a schematic drawing of a low power remote sensor optical gate communication links solution;

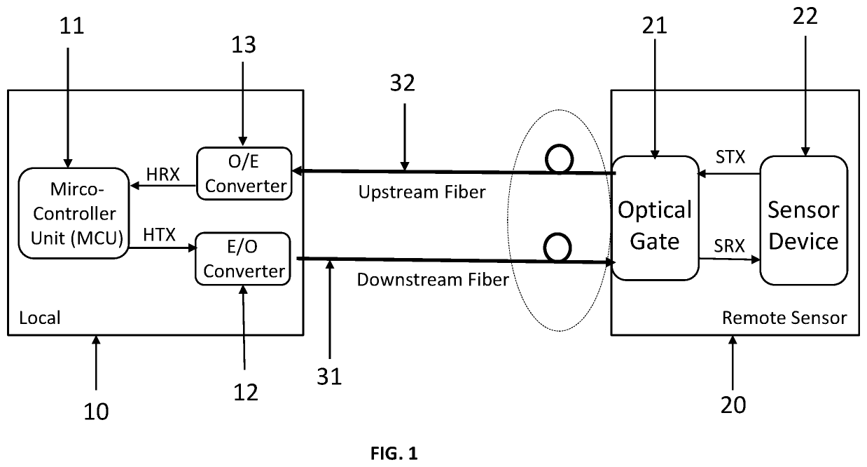

FIG. 2 is a schematic drawing of the optical fiber link for multiple remote low power sensors solution of the present invention;

FIG. 3 is a schematic drawing of the functional block of the multi-Wavelength Local Controller design of the present invention;

FIG. 4 is a schematic drawing of the functional block of the AD-Remote Sensor Station design of the present invention;

FIG. 5 is a schematic drawing of the functional block of the Fault Tolerance with multiple fiber cable links design of the present invention;

FIG. 6 is a schematic drawing of the functional block of the Fault Tolerance Multi-Wavelength Local Controller design of the present invention;

FIG. 7 is schematic drawing of the functional block of the Fault Tolerance AD-Remote Sensor Station design of the present invention;

FIG. 8 is schematic drawing of the method to measure the distance between Multi-Wavelength Local Controller and AD-Remote Sensor Station of the present invention;

FIG. 9 is schematic drawing of the method to detect the cut/broken fiber link cable's segment of the present invention; and

FIG. 10 is schematic drawing of the method to non-interrupted service to install new Fault Tolerance AD-Remote Sensor Station of the present invention.

### DETAILED DESCRIPTION OF THE PREFERRED EMBODIMENTS

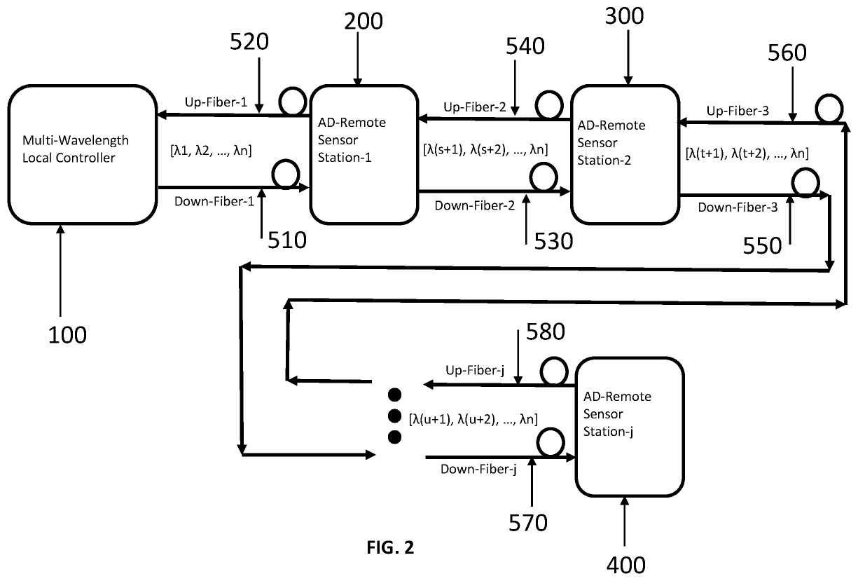

In the previous patent, one remote sensor is using one pair of fiber cable link. This is not a practical design for the remote sensor applications. In order to improve the system to service more remote sensors with one pair of fiber cable link, the present invention uses n*wavelengths, λ1, λ2, . . . , λn, to support n*remote sensors in one pair of fiber cable link in FIG. 2. The Multi-Wavelength Local Controller 100 will generate n*wavelengths, λ1, λ2, . . . , λn, and send the n*wavelengths by the Downstream Fiber 510/530/550/570 (Down-Fiber). The AD-Remote Sensor Station drops x*wavelengths from the Down-Fiber and passes them to the Remote Sensors attached to the AD-Remote Sensor Station. For example, the AD-Remote Sensor Station-1 200 drops s*wavelengths, λ1, λ2, . . . , λs, and allows (n−s)*wavelengths, X(s+1), X(s+2), . . . , λn, to pass through for use at the next AD-Remote Sensor Stations 200/300/400. Each AD-Remote Sensor Station supports multiple Remote Sensors up to the maximum wavelengths which drops from the Down-Fiber 510/530/550/570. The AD-Remote Sensor Station 200/300/400 adds those dropped wavelengths from the attached Remote Sensors back to the Upstream Fiber (Up-Fiber) 520/540/560/580. The combined wavelengths from other AD-Remote Sensor Stations are sent back to the Multi-Wavelength Local Controller 100. With present invention, the system can support many AD-Remote Sensor Stations and each AD-Remote Sensor Station can support several Remote Sensors in one pair of fiber cable link.

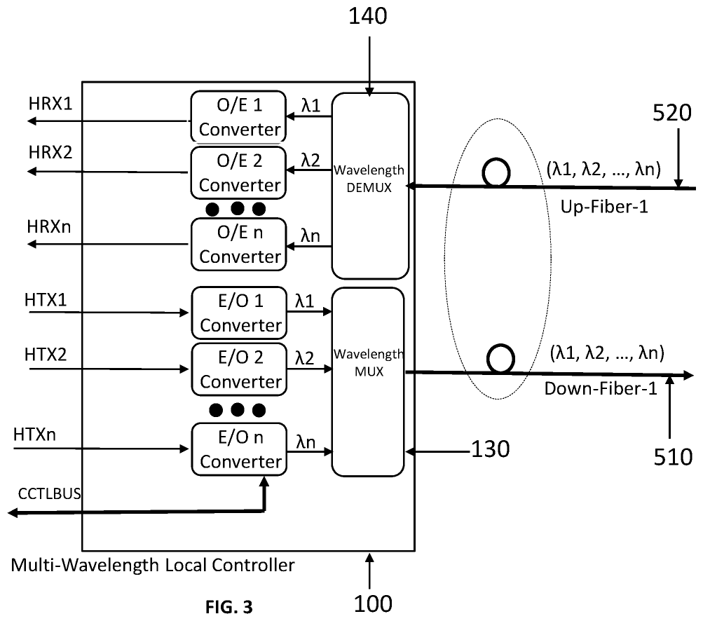

The Multi-Wavelength Local Controller 100, in FIG. 3, provides multiple service signals, HTX1 to HTXn, and CCTLBUS interface for external access. The external device sends the HTXx to remote sensor for communications and control the remote sensor, and also as the laser beam source for the remote sensor's Optical Gate when the HTXx is in HIGH logic level. The external device controls the laser beam's, Xx, output power based on the received laser beam, Xx, power level from the Optical to Electrical converter, O/E x, by the CCTLBUS signals. The CCTLBUS is a serial interface, like the I2C interface. The serial interface is used to read/write the E/O and O/E Converts operating commands, status, and enable or disable the E/O and O/E Converters. If the received laser beam, Xx, power level is lower than setting value, the external device will increase the Electrical to Optical converter, E/O x's, output power to maintain the optical loop in good operating condition. This could happen when the remote sensor is far away from the controller. If the received laser beam, Xx, is higher than the setting value, the external device will reduce the Electrical to Optical converter, E/O x's, output power through the CCTLBUS. The could happen when the remote sensor is very close to the controller. Each service signal, HTXx, controls the related Electrical to Optical converter, E/O x, to generate specific wavelength, λx. The Wavelength Multiplexer (MUX) 130 combines all of the wavelengths, λ1, λ2, . . . , λn, to the Down-Fiber link 510. The Wavelength Demultiplexer (DEMUX) 140 separates the incoming wavelength, λ1, λ2, . . . , an from the UP-Fiber link 520, to each related Optical to Electrical, O/E x, converter and converts to electrical signals, HRX1 to HRXn, for external device to access.

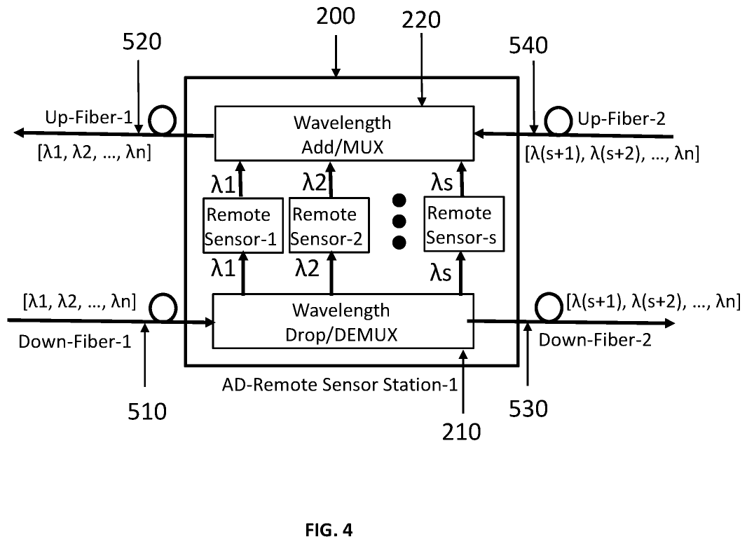

The AD-Remote Sensor Station-1 200, in FIG. 4, uses Wavelength Drop/DEMUX 210 to drop wavelengths, λ1, λ2, . . . , λs, from Down-Fiber-1 510 and passes through the wavelength, X(s+1), X(s+2), . . . , λn, to Down-Fiber-2 530 for other AD-Remote Sensor Stations. Each dropped wavelength is sent to Remote Sensor to process. The processed wavelengths, λ1, λ2, . . . , λs, are combined with other signals λ(s+1), λ(s+2), . . . , λn from the Up-Fiber-2 540 using Wavelength MUX 220 and pass to Up-Fiber-1 520.

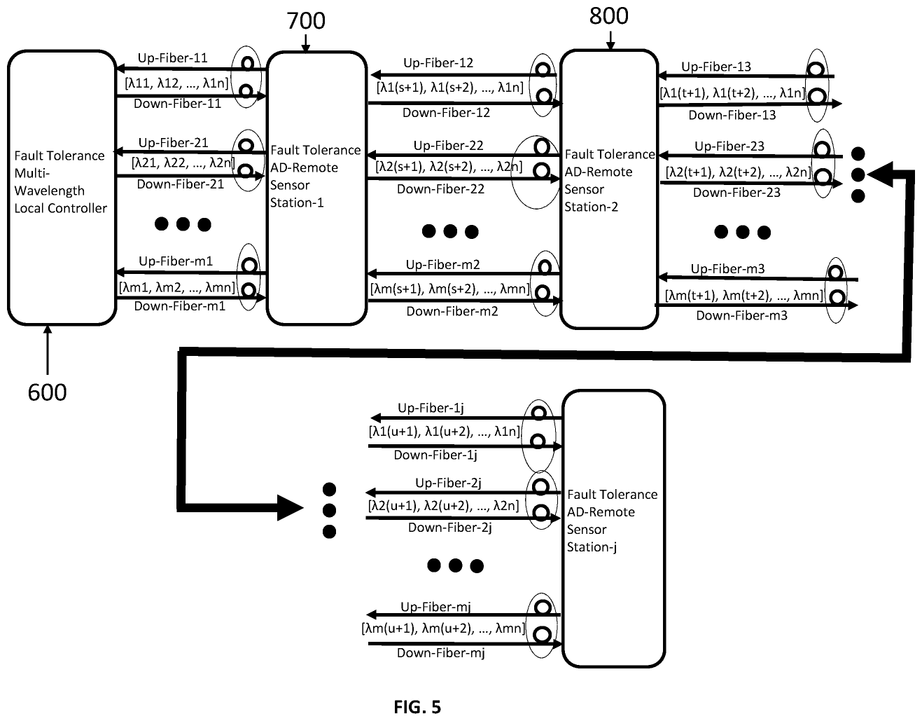

Since most of the remote sensors require reliability in harsh environments, the present invention is designed with multiple fiber cable links for Fault Tolerance capability so that the system can survive when one or more of the fiber cable links are cut or broken. In FIG. 5, the Fault Tolerance sensor system 600 uses m*fiber cable links to carry the same source's wavelengths, [λ11, λ12, . . . , λ1n]/[λ21, λ22, . . . , λ2n]/ . . . / [λm1, λm2, . . . , λmn]. The wavelengths, λ11/λ21/ . . . /λm1, are from the same λ1 and the optical power of λ11/λ21/ . . . /λm1 is 1/m of the λ1. If some of the fiber cable links are cut or broken, the system can still keep partial optical power in other working fiber cable links to keep the system working without interrupting of service.

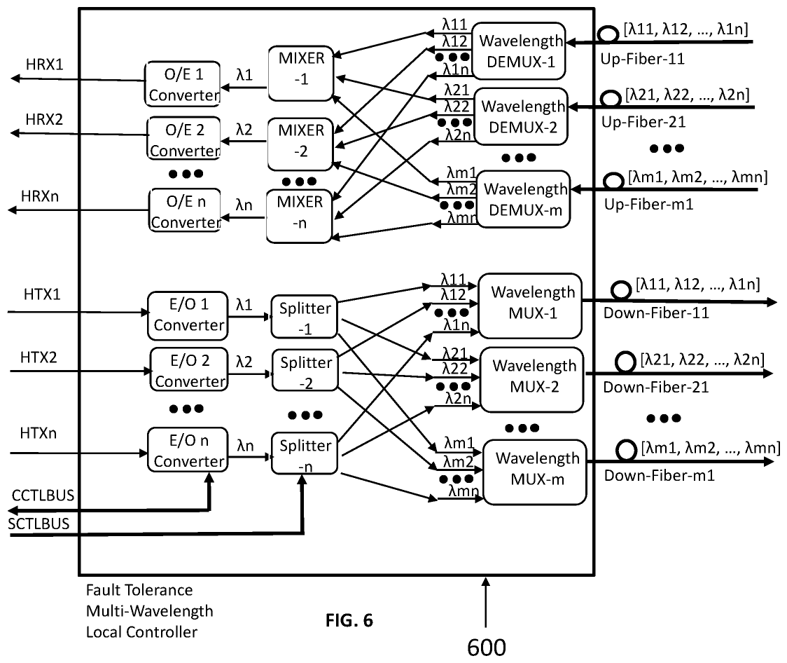

The Fault Tolerance Multi-Wavelength Local Controller 600, in FIG. 6, adds extra Splitters to divide the λ1 to λ11/λ21/ . . . /λm1, λ2 to λ12/λ22/ . . . /λm2, . . . , and λn to λ1n/λ2n/ . . . /λmn. The wavelength λ11/λ12/ . . . /λ1n are combined by the Wavelength MUX-1 to λ11, λ12, . . . , λ1n group and sent to Down-Fiber-1 link, the λ21/λ22/ . . . /λ2n are combined by the Wavelength MUX-2 to λ21, λ22, . . . , λ2n group and sent to Down-Fiber-2 link, . . . , and the λm1, λm2, . . . , λmn are combined by the Wavelength MUX-m to m1, λm2, . . . , λmn group and sent to Down-Fiber-m link. Also, add extra MIXERs to combine the λ11/λ21/ . . . /λm1 to λ1, to combine λ12/λ22/ . . . /λm2 to λ2, . . . , and to combine λ1n/λ2n/ . . . /λmn to an from the Wavelength DEMUXs. The combined λ1/λ2/ . . . /an are sent to related O/E converters and transferred to HRX1/HRX2/ . . . /HRXn signals then sent to external device. The external device controls the Splitter-x to enable or disable each of the output wavelength, λ1x, λ2x, . . . , λmx, by the extra SCTLBUS signals, normally the SCTLBUS is I/O signals to enable or disable the Splitters' each optical output power.

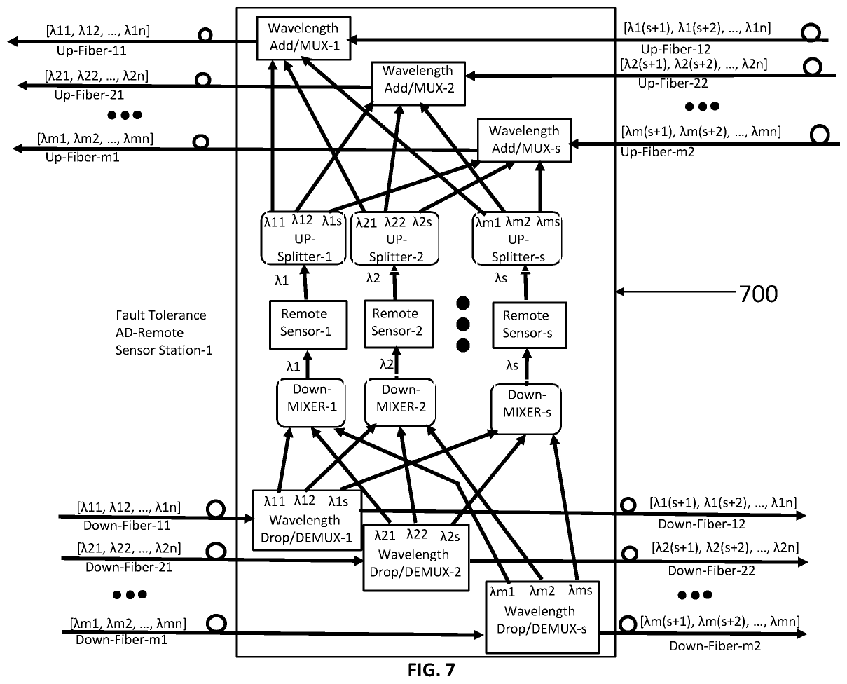

The fault Tolerance AD-Remote Sensor Station 700, in FIG. 7, adds additional Wavelength Drop/DEMUXs to drop the wavelengths, [λ1, λ12, . . . , λ1s]/[λ21, λ22, . . . , λ2s]/ . . . /[λm1, λm2, . . . , λms], from Down-Fiber-11 to Down-Fiber-m1 for this station and passes the unused wavelengths, [λ1(s+1), λ1(s+2), . . . , λ1n]/[λ2(s+1), λ2(s+2), . . . , λ2n]/ . . . /[λm(s+1), λm(s+2), . . . , λmn], to the Down-Fiber-12 to Dow-Fiber-m2. Also adds additional Down-MIXERs to combine related wavelengths, [λ11, λ12, . . . , λ1s], [λ21, λ22, . . . , λ2s], . . . , [λm1, λm2, . . . , λms] to λ1, λ2, . . . , λn and sends them to the related Remote Sensors. The additional UP-Splitters distribute the returned wavelengths, [λ1, λ2, . . . , λs] to [λ11, λ12, . . . , λ1s], [λ21, λ22, . . . , λ2s], . . . , [λm1, λm2, . . . , λms] from Remote Sensors and send to related Wavelength Add/MUX-1 to Wavelength Add/MUX-m. The additional Wavelength Add/MUX-1 to Wavelength Add/MUX-s combine the wavelengths, [λ1(s+1), λ1(s+2), . . . , λ1n]/[λ2(s+1), λ2(s+2), . . . , λ2n]/ . . . /[λm(s+1), λm(s+2), . . . , λmn], from Up-Fiber-12 to Up-Fiber-m2 cable links and combines with the [λ11, λ12, . . . , λ1s]/[λ21, λ22, . . . , λ2s]/ . . . /[λm1, λm2, . . . , λms] to [λ11, λ12, . . . , λ1n]/[λ21, λ22, . . . , λ2n]/ . . . /[λm1, λm2, . . . , λmn] and send them to Up-Fiber-11 to Up-Fiber-m1 fiber links.

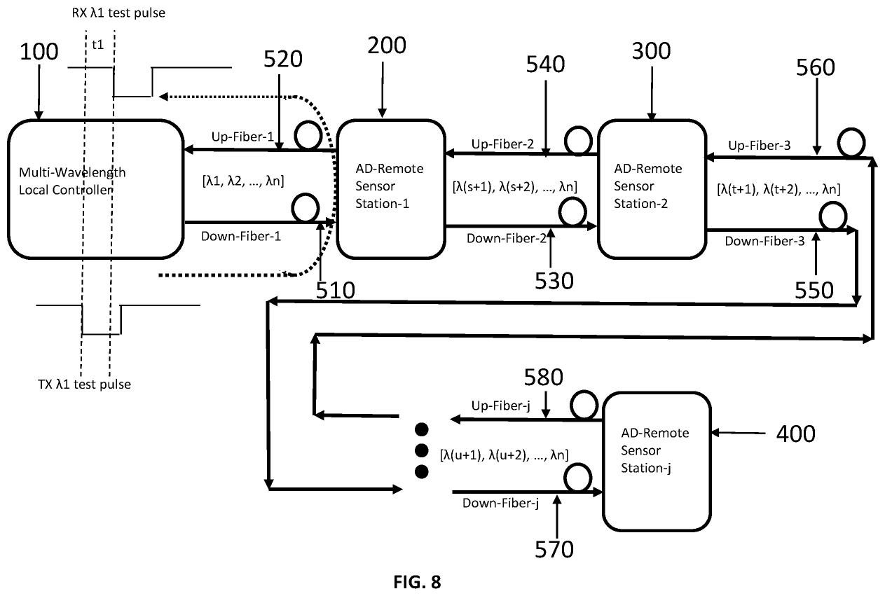

As the laser beam is generated from the Multi-Wavelength Local Controller, the external device can generate a specific negative pulse on the HTXx signal to generate negative pulse on λx wavelength. The negative pulse of the λx wavelength will run through the Down-Fiber 510/530/550/570 and related AD-Remote Sensor Station then return to the controller by the UP-Fiber 520/540/560/580. The external device receives the return negative pulse from the O/E converter-x/HRXx and measure the delay time between HTXx and HRXx. By calculate the delay time, the controller can calculate the distance/fiber cable length of the related AD-Remote Sensor Station-x from the controller 100. For example, the external device can generate a negative pulse on the HTX1 signal and the HTX1 signal with the negative pulse is converted to λ1 by the E/O 1 converter. The λ1 is carried by the Down-Fiber-1 510 and returned by the AD-Remote Sensor Station 1 200 and carried by the Up-Fiber-1 520 to the controller 100. The external device receives returned negative pulse/HIRX1 as in FIG. 8. To measure the delay time between HTX1 and HRX1, t1, by the external device, the cable segment length can be calculated as (½)*t1*C, where C is the speed of light.

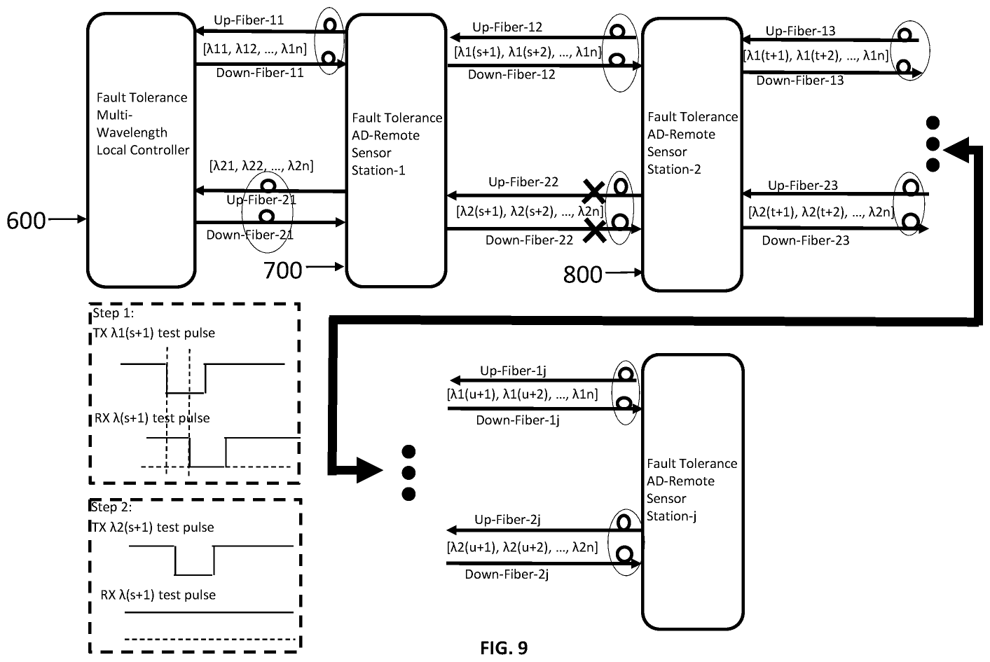

Also, it is possible to detect the cut/broken fiber cable segment as in FIG. 9. By using the two fiber cables for fault tolerance applications, if the fiber cable-22 link is cut/broken between Fault Tolerance AD-Remote Sensor Station-1 700 and Station-2 800, the Fault Tolerance Local Controller 600 can detect the cut/broken fiber cable link by measuring the returned laser beams' optical power change. In this example, all of the wavelengths, λ(s+1), λ(s+2), . . . , λn, will have 6 dB power drop when the fiber cable-22 segment is broken. The system can send the negative pulse on the λ1(s+1) and λ2(s+1) or one of the [λ1(s+1), λ1(s+2), . . . , λ1n]/[λ2(s+1), λ2(s+2), . . . , λ2n] to test the fiber cable link condition. For example, in Step 1, the returned λ(s+1) test pulse is measured. It means the fiber cable link 1 is in good working condition. In the Step 2, the returned λ(s+1) optical power has no change. In means the fiber cable link-2 segment between Fault Tolerance AD-Remote Sensor Station-1 700 and Station-2 800 is cut/broken.

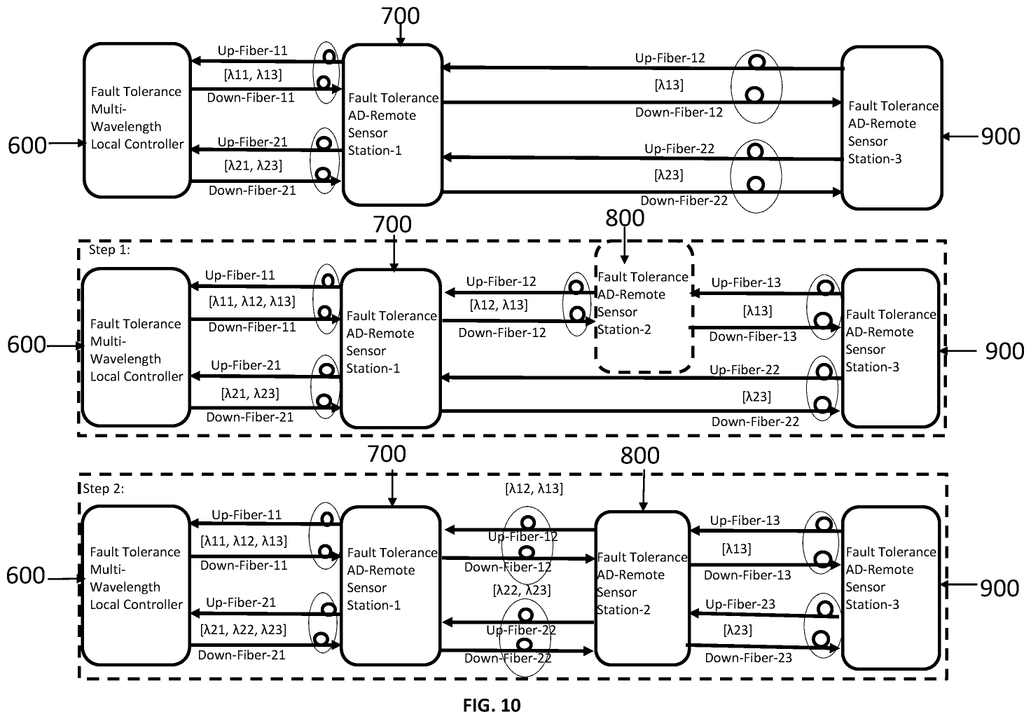

Also, the multiple fiber cable links design can allow the user to add new Fault Tolerance Station to the existing services without interrupting the existing services. As the example in FIG. 10 shows, the new Fault Tolerance AD-Remote Sensor Station-2 800 will be added to the system between the Fault Tolerance AD-Remote Sensor Station-1 700 and Fault Tolerance AD-Remote Sensor Station-3 900. Step 1 is to cut fiber cable-12 link and insert new Station-2 800 to the fiber cable link-12. During the operating, the system is still working in 6 dB optical power lose by the fiber cable-22 link, but not interrupting of the services. After complete the Step 1, the Step 2 is to cut and insert the fiber cable-22 link to Station-2. The same as the Step 1, there is no interrupting of service since the fiber cable-12 link is in operation and keep the system work.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. An optical fiber link, comprising:
a first pair of fiber cable link including a first up fiber and a first down fiber;
a multi-wavelength controller configured to generate a plurality of wavelengths and send the plurality of wavelengths to a first AD-remote sensor station by a first down fiber, wherein the first AD-remote sensor station includes a first number of remote sensors; and
a plurality of AD-remote sensor stations including the first AD-remote sensor station and a second AD-remote sensor station,
wherein the first AD-remote sensor station is configured to drop the first number of the plurality of wavelengths for the first number of remote sensors to process, and allow the rest of the plurality of wavelengths to pass to the second Ad-remote sensor station by the first down fiber; and
wherein the first AD-remote sensor station is further configured to add the dropped first number of the plurality of wavelengths processed by the first number of remote sensors back to the first up fiber, and send a first combined wavelengths including the first number of the plurality of wavelengths processed by the first AD-remote sensor station and a second combined wavelengths processed by the second AD-remote sensor station back to the multi-wavelength controller.

2. The optical fiber link according to claim 1, wherein the multi-wavelength controller comprises:
a plurality of Electrical to Optical (E/O) converters configured to receive a plurality of service signals, and to generate the plurality of wavelengths respectively;
a wavelength multiplexer (MUX) configured to combine the plurality of wavelengths to the first down fiber;
a wavelength demultiplexer (DEMUX) configured to separate the first combined wavelengths from the first up fiber to each corresponding one of a plurality of Optical to Electrical (O/E) converters; and
the plurality of Optical to Electrical (O/E) converters configured to convert the first combined wavelengths to electrical signals.

3. The optical fiber link according to claim 1, wherein the first AD-remote sensor station further comprises:
a first wavelength Drop/DEMUX configured to drop the first number of the plurality of wavelengths from the first down fiber and send the first number of the plurality of wavelengths to the first number of remote sensors to process respectively; and
a first wavelength Add/MUX configured to combine the first number of the plurality of wavelengths processed by the first number of remote sensors with the second combined wavelengths processed by the second AD-remote sensor station from the first up fiber, and pass the first combined wavelengths to the first up fiber.

4. The optical fiber link according to claim 3, wherein the second AD-remote sensor station comprises:
a second number of remote sensors;
a second wavelength Drop/DEMUX configured to drop a second number of the plurality of wavelengths from the first down fiber and send the second number of the plurality of wavelengths to the second number of remote sensors in the second AD-remote sensor station to process respectively; and
a second wavelength Add/MUX configured to combine the second number of the plurality of wavelengths processed by the second number of remote sensors with a third number of the plurality of wavelengths from the first up fiber, and pass the second combined wavelengths to the first up fiber.

5. The optical fiber link according to claim 1, further comprising:
a second pair of fiber cable link including a second up fiber and a second down fiber connected between the multi-wavelength controller and the first AD-remote sensor station, and between the first AD-remote sensor station and the second AD-remote sensor station,
wherein the plurality of wavelengths are sent to the first AD-remote sensor station by both the first down fiber and the second down fiber,
wherein the first AD-remote sensor station is configured to drop the first number of the plurality of wavelengths for the first number of remote sensors to process, and allow the rest of the plurality of wavelengths to pass to the second Ad-remote sensor station by both the first down fiber and the second down fiber, and
wherein the first AD-remote sensor station is further configured to add the dropped first number of the plurality of wavelengths processed by the first number of remote sensors back to both the first up fiber and the second up fiber, and send the first combined wavelengths back to the multi-wavelength controller by both the first up fiber and the second up fiber.

6. The optical fiber link according to claim 5, wherein the plurality of wavelengths includes a plurality of first sub-wavelengths and a plurality of second sub-wavelengths, the plurality of first sub-wavelengths are transmitted by the first pair of fiber cable link, the plurality of second sub-wavelengths are transmitted by the second pair of fiber cable link, and the plurality of first sub-wavelengths and the plurality of first sub-wavelengths are the same and have the same optical power.

7. The optical fiber link according to claim 5, wherein the multi-wavelength controller comprises:
a plurality of Electrical to Optical (E/O) converters configured to receive a plurality of service signals and to generate the plurality of wavelengths respectively;
a plurality of splitters each configured to split a corresponding one of the plurality of wavelength to a first sub-wavelength and a second sub-wavelength, the first sub-wavelength and the second sub-wavelength being the same and having the same optical power;
a first wavelength multiplexer (MUX) configured to combine a plurality of the first sub-wavelengths to the first down fiber;
a second wavelength multiplexer (MUX) configured to combine a plurality of the second sub-wavelengths to the second down fiber;
a first wavelength demultiplexer (DEMUX) configured to separate a combined first sub-wavelengths from the first up fiber to a plurality of mixers;
a second wavelength demultiplexer (DEMUX) configured to separate a combined second sub-wavelengths from the second up fiber to the plurality of mixers;
the plurality of mixers configured to combine the combined first sub-wavelengths and the combined second sub-wavelengths to generate the first combined plurality of wavelengths, and send the first combined wavelengths to the plurality of Optical to Electrical (O/E) converters; and
the plurality of Optical to Electrical (O/E) converters configured to convert the first combined wavelengths to electrical signals.

8. The optical fiber link according to claim 6,
wherein the first combined wavelengths include a first combined first sub-wavelengths and a first combined second sub-wavelengths, and the second combined wavelengths includes a second combined first sub-wavelengths and a second combined second sub-wavelengths,
wherein the first wavelength Drop/DEMUX is configured to drop the first number of the plurality of first sub-wavelengths of the plurality of wavelengths from the first down fiber and send the first number of the plurality of first sub-wavelengths of the plurality of wavelengths to the first number of remote sensors to process respectively,
wherein the first wavelength Add/MUX is configured to combine the first number of the plurality of first sub-wavelengths of the plurality of wavelengths processed by the first number of remote sensors with the second combined first sub-wavelengths processed by the second AD-remote sensor station from the first up fiber, and pass the first combined first sub-wavelengths to the first up fiber, and
wherein the first AD-remote sensor station further comprises:
a second wavelength Drop/DEMUX configured to drop the first number of the plurality of second sub-wavelengths of the plurality of wavelengths from the second down fiber and send the first number of the plurality of second sub-wavelengths of the plurality of wavelengths to the first number of remote sensors to process respectively; and
a second wavelength Add/MUX configured to combine the first number of the plurality of second sub-wavelengths of the plurality of wavelengths processed by the first number of remote sensors with the second combined second sub-wavelengths processed by the second AD-remote sensor station from the second up fiber, and pass the first combined second sub-wavelengths to the second up fiber.

9. The optical fiber link according to claim 8, wherein the second AD-remote sensor station comprises:
a second number of remote sensors;
a third wavelength Drop/DEMUX configured to drop a second number of the plurality of first sub-wavelengths of the plurality of wavelengths from the first down fiber and send the second number of the plurality of first sub-wavelengths of the plurality of wavelengths to the second number of remote sensors in the second AD-remote sensor station to process respectively;
a four wavelength Drop/DEMUX configured to drop the second number of the plurality of second sub-wavelengths of the plurality of wavelengths from the second down fiber and send the second number of the plurality of second sub-wavelengths of the plurality of wavelengths to the second number of remote sensors in the second AD-remote sensor station to process respectively;
a third wavelength Add/MUX configured to combine the second number of the plurality of first sub-wavelengths of the plurality of wavelengths processed by the second number of remote sensors with a third number of the plurality of first sub-wavelengths of the plurality of wavelengths from the first up fiber, and pass the second combined first sub-wavelengths to the first up fiber; and
a fourth wavelength Add/MUX configured to combine the second number of the plurality of second sub-wavelengths of the plurality of wavelengths processed by the second number of remote sensors with the third number of the plurality of second sub-wavelengths of the plurality of wavelengths from the second up fiber, and pass the second combined second sub-wavelengths to the second up fiber.

10. The optical fiber link according to claim 1, wherein multi-wavelength controller is configured to generate a wavelength with a negative pulse and receive the wavelength with a returned negative pulse to measure a delay time therebetween and calculate a length of the first pair of fiber cable link.

11. A method, comprising:
performing transmission by using the optical fiber link according to claim 5; and
detecting a non-functional fiber link cable, comprising the sub-steps of:
sending a first test pulse via the first down fiber;
measuring a first return test pulse received from the first up fiber to determine a condition of the first pair of fiber cable link;
sending a second test pulse via the second down fiber; and
measuring a second return test pulse received from the second up fiber to determine a condition of the second pair of fiber cable link.

12. A method, comprising:
performing transmission by using the optical fiber link according to claim 5; and
installing a new fault tolerance AD-Remote sensor station without interrupted the transmission, comprising the sub-steps of:
cutting the first pair of fiber cable link between the first AD-remote sensor station and the second AD-remote sensor station while the transmission is carried out by the second pair of fiber cable link;
inserting a third AD-remote sensor station between the first AD-remote sensor station and the second AD-remote sensor station;
establishing connections between the third AD-remote sensor station with the first pair of fiber cable link;
recovering the transmission carried out by the first pair of fiber cable link;
cutting the second pair of fiber cable link between the first AD-remote sensor station and the second AD-remote sensor station while the transmission is carried out by the first pair of fiber cable link;
establishing connections between the third AD-remote sensor station with the second pair of fiber cable link; and
recovering the transmission carried out by the second pair of fiber cable link.
